(19) United States
(12) Patent Application Publication
(10) Pub. No.: US 2024/0082792 A1
(43) Pub. Date: Mar. 14, 2024

(54) NEW PROCESS FOR THE SEPARATION OF PROPYLENE FROM A GAS MIXTURE (GM) COMPRISING PROPYLENE AND PROPANE

(71) Applicants: BASF SE, Ludwigshafen am Rhein (DE); National University of Singapore, Singapore (SG)

(72) Inventors: Canzeng LIANG, Singapore (SG); Martin WEBER, Ludwigshafen am Rhein (DE); Wai YONG, Singapore (SG); Christian MALETZKO, Ludwigshafen am Rhein (DE); Tai-Shung CHUNG, Singapore (SG)

(21) Appl. No.: 18/271,679

(22) PCT Filed: Jan. 5, 2022
(86) PCT No.: PCT/EP2022/050132

§ 371 Date: Jul. 11, 2023

(30) Foreign Application Priority Data
Jan. 12, 2021 (EP) 21151175.3

(51) Int. Cl. B01D 71/68; B01D 67/00; B01D 69/08

(52) U.S. Cl. CPC B01D 71/68; B01D 67/0006; B01D 69/08; B01D 2256/24; B01D 2323/219

(57) ABSTRACT

The present invention relates to a process for the separation of propylene from a gas mixture (GM) comprising propylene and propane by means of a membrane (M) comprising a polyarylene ether sulfone polymer (P) prepared by converting a reaction mixture (R_{G}) comprising at least one aromatic dihalogen sulfone and at least one dihydroxy component comprising trimethylhydroquinone.

The present invention relates to a process for the separation of propylene from a gas mixture (GM) comprising propylene and propane by means of a membrane (M) comprising a polyarylene ether sulfone polymer (P) prepared by converting a reaction mixture (R_{G}) comprising at least one aromatic dihalogen sulfone and at least one dihydroxy component comprising trimethylhydroquinone.

Membrane technologies for gas separations and purifications have been industrialized since the late 1970s, and are continually growing and advancing due to their economic and environmental benefits as compared to the conventional processes such as sorption and distillation.

However, plasticization is one of the prevalent and detrimental issues for gas-separation using polymeric membranes. Plasticization of polymeric membranes is mainly induced by highly condensable gases like CO₂, H₂S, propylene (C₃H₆) and propane (C₃H₈). Highly condensable gases tend to dissolve in polymeric membranes and swell up the polymer matrices, resulting in wider gas diffusion paths and higher chain mobility. As a result, the plasticization usually leads to a higher gas permeability and/or permeance, but a lower selectivity.

Therefore, in the state of the art polymeric membranes are mainly used for the separation of gases which are not highly condensable like O₂, N₂, CH₄, CO₂ and the like because these gases do not induce plasticization of polymeric membranes.

To overcome the plasticization effects induced by highly condensable gases for the separation of these gases in the state of the art mainly inorganic membranes such as metal-organic framework (MOF), graphene and graphene oxide (GO), and carbon molecular sieves are used. However, these membranes are expensive and difficult to be scaled up or commercialized.

Among many gases, propylene is an important monomer that is separated from a propylene/propane mixture, which is usually produced by the thermal cracking of hydrocarbons. The conventional method to separate propylene and propane is cryogenic distillation, which is a highly energy-intensive process. Moreover, traditional polymeric membranes are found to be difficult to separate propylene and propane in a productive and efficient way because propylene and propane have a very small difference (˜0.1 Å) in their effective sizes and they are highly condensable and, therefore, induce membrane plasticization.

It is, therefore, an object of the present invention to provide a process for the separation of propylene from a gas mixture comprising propylene and propane by means of a polymeric membrane which does not retain the disadvantages of the prior art or only in diminished form.

This object is achieved by a process for the separation of propylene from a gas mixture (GM) comprising propylene and propane by means of a membrane (M) comprising a polyarylene ether sulfone polymer (P) prepared by converting a reaction mixture (R_{G}) comprising at least one aromatic dihalogen sulfone and at least one dihydroxy component comprising trimethylhydroquinone.

It has surprisingly been found that by the inventive process propylene can be separated from a gas mixture (GM) comprising propylene and propane in a simple and cost effective way. The membrane (M) comprising the polyarylene ether sulfone polymer (P) does not show the disadvantages of the prior art or only in diminished form, especially the membrane (M) comprising the polyarylene ether sulfone polymer (P) does not show a loss of selectivity due to plasticization. The membrane (M) comprising the polyarylene ether sulfone polymer (P), moreover, shows an exceptionally high C₃H₆ permeance, a high C₃H₆/C₃H₈ selectivity and high durability.

The present invention will be described in more detail hereinafter.

In the inventive process for the separation of propylene from the gas mixture (GM) a membrane (M) comprising a polyarylene ether sulfone polymer (P) is used.

### Polyarylene Ether Sulfone Polymer (P)

The polyarylene ether sulfone polymer (P) comprised in the membrane (M) used in the inventive process is prepared by converting a reaction mixture (R_{G}) comprising at least one aromatic dihalogen sulfone and at least one dihydroxy component comprising trimethylhydroquinone.

In a preferred embodiment the preparation of the polyarylene ether sulfone polymer (P) comprised in the membrane (M) used in the inventive process comprises the step
I) converting a reaction mixture (R_{G}) comprising as components
   (A1) at least one aromatic dihalogen sulfone,
   (B1) at least one dihydroxy component comprising at least 20 mol-% of trimethylhydroquinone based on the total amount of the at least one dihydroxy component,
   (C) at least one carbonate component,
   (D) at least one aprotic polar solvent.

The polyarylene ether sulfone polymer (P) comprised in the membrane (M) used in the inventive process, in a preferred embodiment, therefore, comprises units that are derived from component (A1) and units that are derived from component (B1). In a more preferred embodiment, the polyarylene ether sulfone polymer (P) consists of units that are derived from component (A1) and units that are derived from component (B1). To the person skilled in the art it is clear, that if in one embodiment of the present invention step II) (as described in below in view of the process for the preparation of the polyarylene ether sulfone polymer (P)) is carried out then at least some of the polyarylene ether sulfone polymer (P) endgroups are not derived from components (A1) and (B1).

In a further preferred embodiment, the polyarylene ether sulfone polymer (P) comprises units of formula (Ia) and/or formula (Ib).

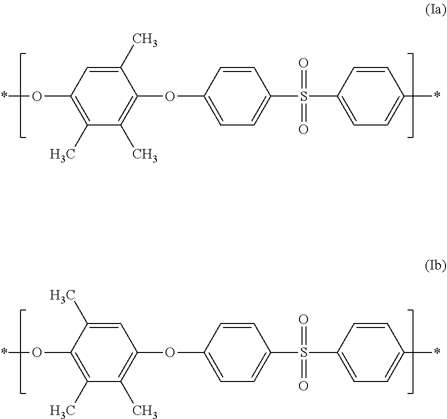

In formulae (Ia) and (Ib) * indicates a bond. This bond can, for example, be a link to another unit of formula (Ia) or (Ib) or a link to an alkyl or an alkoxy endgroup as described below.

To the person skilled in the art it is clear that formulae (Ia) and (Ib) encompass possible isomers of the formulae as well.

It is preferred that the polyarylene ether sulfone polymer (P) comprises at least 40% by weight of units of the formulae (Ia) and/or (Ib), more preferably at least 80% by weight and most preferably at least 90% by weight of units of formulae (Ia) and/or (Ib), based on the total weight of the polyarylene ether sulfone polymer (P).

It is furthermore preferred that the polyarylene ether sulfone polymer (P) consists essentially of units of formulae (Ia) and/or (Ib).

“Consisting essentially of” within the context of the present invention, means that the polyarylene ether sulfone polymer (P) comprises more than 99% by weight and preferably more than 99.5% by weight of units of formulae (Ia) and/or (Ib).

It is further preferred that the polyarylene ether sulfone polymer (P) consists of units of formulae (Ia) and/or (Ib).

To the person skilled in the art it is clear that, even if the polyarylene ether sulfone polymer (P) consists of units of formulae (Ia) and/or (Ib), the polyarylene ether sulfone polymer (P) comprises end groups that differ from units of formulae (Ia) and/or (Ib).

The polyarylene ether sulfone polymer (P) obtainable by the inventive process preferably has a weight average molecular weight (M_{w}) in the range from 15 000 to 180 000 g/mol, more preferably in the range from 20 000 to 150 000 g/mol and particularly preferably in the range from 25 000 to 125 000 g/mol, determined by GPC (Gel Permeation Chromatography). GPC-Analysis is done using Dimethylacetamide with 0.5 wt. % LiBr as solvent, the polymer concentration is 4 mg/mL. The system was calibrated with PMMA-standards. As columns three different Polyestercopolymer based units were used. After dissolving the material, the obtained solution was filtered using a filter with 0.2 μm pore size, then 100 μL solution were injected into the system, the elution rate was set at 1 mL/min.

The polyarylene ether sulfone polymer (P) obtainable by the inventive process furthermore, has preferably a number average molecular weight (Mₙ) in the range from 5 000 to 75 000 g/mol, more preferably in the range from 6 000 to 60 000 g/mol and particularly preferably in the range from 7 500 to 50 000 g/mol, determined by GPC (Gel Permeation Chromatography). GPC-analysis is performed as described above.

The glass transition temperature (T_{G}) of the polyarylene ether sulfone polymer (P) is typically in the range from 230 to 260° C., preferably in the range from 235 to 255° C. and particularly preferably in the range from 240 to 250° C. determined via differential scanning calorimetry (DSC) with a heating rate of 10 K/min in the second heating cycle.

The viscosity number (V.N.) of the polyarylene ether sulfone polymer (P) is determined as a 1% solution in N-methylpyrrolidone at 25° C. The viscosity number (V.N.) is typically in the range from 50 to 120 ml/g, preferably in the range from 55 to 100 ml/g and most preferably in the range from 60 to 90 ml/g.

If step II) (as described in below in view of the process for the preparation of the polyarylene ether sulfone polymer (P)) is carried out for the preparation of a polyarylene ether sulfone polymer (P), then the obtained polyarylene ether sulfone polymer (P) usually comprises alkoxy endgroups. The alkoxy endgroups result from the reaction of the alkyl halide with at least some of the hydroxy endgroups of the first polymer (P1) obtained in this embodiment of the invention in step I). The polyarylene ether sulfone polymer (P) can furthermore comprise halogen-endgroups which are derived from component (A1) and/or hydroxy end groups derived from component (B1). This is known to the person skilled in the art.

An “alkoxy endgroup” within the context of the present invention is an alkyl group bonded to an oxygen. The alkylgroup is particularly a linear or branched alkyl group having from 1 to 10 carbon atoms, in particular a methyl group. Therefore, the alkoxy group is preferably a methoxy (MeO) group.

The polyarylene ether sulfone polymer (P) then usually comprises at least 5% of alkoxy endgroups, preferably at least 50% and most preferably at least 65% of alkoxy endgroups, based on the total of all endgroups of the polyarylene ether sulfone polymer (P). The polyarylene ether sulfone polymer (P) then usually comprises at most 100%, preferably at most 80% and most preferably at most 50% of alkoxy endgroups, based on the total of all endgroups of the polyarylene ether sulfone polymer (P).

The process for the preparation of the polyarylene ether sulfone polymer (P) comprised in the membrane (M) used in the inventive process for the separation of propylene from a gas mixture (GM) comprising propylene and propane will be described in more detail hereinafter.

### Process for the Preparation of the Polyarylene Ether Sulfone Polymer (P)

General information regarding the formation of polyarylene ether sulfone polymers by the hydroxide method is found inter alia in R.N. Johnson et. al., J. Polym. Sci. A-1 5 (1967) 2375, while the carbonate method is described in J. E. McGrath et. al., Polymer 25 (1984) 1827.

Methods of forming polyarylene ether sulfone polymers from aromatic bishalogen compounds and aromatic bisphenols or salts thereof in an aprotic solvent in the presence of one or more alkali metal or ammonium carbonates or bicarbonates are known to a person skilled in the art and are described in EP-A 297 363 and EP-A 135 130, for example.

The preparation of the polyarylene ether sulfone polymer (P), in a preferred embodiment, comprises step I) converting a reaction mixture (R_{G}) comprising the components (A1), (B1), (C) and (D) described above.

The components (A1) and (B1) enter into a polycondensation reaction.

Component (D) acts as a solvent and component (C) acts as a base to deprotonate component (B1) during the condensation reaction.

Reaction mixture (R_{G}) is understood to mean the mixture that is used in the process according to the present invention for preparing the polyarylene ether sulfone polymer (P). In the present case all details given with respect to the reaction mixture (R_{G}) thus, relate to the mixture that is present prior to the polycondensation. The polycondensation takes place during the process according to the invention in which the reaction mixture (R_{G}) reacts by polycondensation of components (A1) and (B1) to give the target product, the polyarylene ether sulfone polymer (P). The mixture obtained after the polycondensation which comprises the polyarylene ether sulfone polymer (P) target product is also referred to as product mixture (P_{G}). The product mixture (P_{G}) usually furthermore comprises the at least one aprotic polar solvent (component (D)) and a halide compound. The halide compound is formed during the conversion of the reaction mixture (R_{G}). During the conversion first, component (C) reacts with component (B1) to deprotonate component (B1). Deprotonated component (B1) then reacts with component (A1) wherein the halide compound is formed. This process is known to the person skilled in the art.

In one embodiment of the present invention in step I) a first polymer (P1) is obtained. This embodiment is described in more detail below. In this embodiment the product mixture (P_{G}) comprises the first polymer (P1). The product mixture (P_{G}) then usually furthermore comprises the at least one aprotic polar solvent (component (D)) and a halide compound. For the halide compound the above described details hold true.

The components of the reaction mixture (R_{G}) are generally reacted concurrently. The individual components may be mixed in an upstream step and subsequently be reacted. It is also possible to feed the individual components into a reactor in which these are mixed and then reacted.

In the process according to the invention, the individual components of the reaction mixture (R_{G}) are generally reacted concurrently in step I). This reaction is preferably conducted in one stage. This means, that the deprotonation of component (B1) and also the condensation reaction between components (A1) and (B1) take place in a single reaction stage without isolation of the intermediate products, for example the deprotonated species of component (B1).

The process according to step I) of the invention is preferably carried out according to the so called “carbonate method”.

It is furthermore preferred that the reaction mixture (R_{G}) does not comprise toluene. It is particularly preferred that the reaction mixture (R_{G}) does not comprise any substance which forms an azeotrope with water.

The ratio of component (A1) and component (B1) derives in principal from the stoichiometry of the polycondensation reaction which proceeds with theoretical elimination of hydrogen chloride and it is established by the person skilled in the art in a known manner.

Preferably, the ratio of halogen end groups derived from component (A1) to phenolic end groups derived from component (B1) is adjusted by controlled establishment of an excess of component (B1) in relation to component (A1) as starting compound.

More preferably, the molar ratio of component (B1) to component (A1) is from 0.97 to 1.08, especially from 0.98 to 1.06, most preferably from 0.99 to 1.05.

Preferably, the conversion in the polycondensation reaction is at least 0.9.

Process step I) for the preparation of the polyarylene ether sulfone polymer (P) is typically carried out under conditions of the so called “carbonate method”. This means that the reaction mixture (R_{G}) is reacted under the conditions of the so called “carbonate method”. The reaction (polycondensation reaction) is generally conducted at temperatures in the range from 80 to 250° C., preferably in the range from 100 to 220° C. The upper limit of the temperature is determined by the boiling point of the at least one aprotic polar solvent (component (D)) at standard pressure (1013.25 mbar). The reaction is generally carried out at standard pressure. The reaction is preferably carried out over a time interval of 0.5 to 12 h, particularly in the range from 1 to 10 h.

The isolation of the obtained polyarylene ether sulfone polymer (P) in the product mixture (P_{G}) may be carried out for example by precipitation of the product mixture (P_{G}) in water or mixtures of water with other solvents. The precipitated polyarylene ether sulfone polymer (P) can subsequently be extracted with water and then be dried. In one embodiment of the invention, the precipitate can also be taken up in an acidic medium. Suitable acids are for example organic or inorganic acids for example carboxylic acid such as acetic acid, propionic acid, succinic acid or citric acid and mineral acids such as hydrochloric acid, sulfuric acid or phosphoric acid.

In one embodiment in step I) a first polymer (P1) is obtained. The process for the preparation of the polyarylene ether sulfone polymer (P) then preferably additionally comprises step

II) reacting the first polymer (P1) obtained in step I) with an alkyl halide.

To the person skilled in the art it is clear that if step II) is not carried out then the first polymer (P1) corresponds to the polyarylene ether sulfone polymer (P).

The first polymer (P1) usually is the product of the polycondensation reaction of component (A1) and component (B1) comprised in the reaction mixture (R_{G}). The first polymer (P1) can be comprised in the above-described product mixture (P_{G}), which is obtained during the conversion of the reaction mixture (R_{G}). As described above, this product mixture (P_{G}) comprises the first polymer (P1), component (D) and a halide compound. The first polymer (P1) can be comprised in this product mixture (P_{G}) when it is reacted with the alkyl halide.

In one embodiment, the halide compound is separated off from the product mixture (P_{G}) after step I) and before step II) to obtain a second product mixture (P2_{G}). The second product mixture (P2_{G}) then comprises the at least one solvent (component (D)), the first polymer (P1) and, optionally, traces of the halide compound.

“Traces of the halide compound” within the context of the present invention means less than 0.5% by weight, preferably less than 0.1% by weight and most preferably less than 0.01% by weight of the halide compound, based on the total weight of the second product mixture (P2_{G}). The second product mixture (P2_{G}) usually comprises at least 0.0001% by weight, preferably at least 0.0005% by weight and most preferably at least 0.001% by weight of the halide compound, based on the total weight of the second product mixture (P2_{G}).

The separation of the halide compound from the first product mixture (P1) can be carried out by any method known to the skilled person, for example via filtration or centrifugation.

The first polymer (P1) usually comprises terminal hydroxy groups. In step II) these terminal hydroxy groups are further reacted with the alkyl halide to obtain the polyarylene ether sulfone polymer (P). Preferred alkyl halides are in particular alkyl chlorides having linear or branched alkyl groups having from 1 to 10 carbon atoms, in particular primary alkyl chlorides, particularly preferably methyl halides, in particular methyl chloride.

The reaction according to step II) is preferably carried out at a temperature in the range from 90° C. to 160° C., in particular in the range from 100° C. to 150° C. The time required can vary over a wide range of times and is usually at least 5 minutes, in particular at least 15 minutes. It is preferable that the time required for the reaction according to step II) is from 15 minutes to 8 hours, in particular from 30 minutes to 4 hours.

Various methods can be used for the addition of the alkyl halide. It is moreover possible to add a stoichiometric amount or an excess of the alkyl halide, and the excess can be by way of example by up to 5-fold. In one preferred embodiment the alkyl halide is added continuously, in particular via continuous introduction in the form of a gas stream.

In step II) usually a polymer solution (PL) is obtained which comprises the polyarylene ether sulfone polymer (P) and component (D). If in step II) the product mixture (P_{G}) from step I) was used, then the polymer solution (PL) typically furthermore comprises the halide compound. It is possible to filter the polymer solution (PL) after step II). The halide compound can thereby be removed.

In a preferred embodiment the process for the preparation of the polyarylene ether sulfone polymer (P) furthermore comprises step

III) filtration of the polymer solution (PL) obtained in step II).

The isolation of the obtained polyarylene ether sulfone polymer (P) obtained in the step II) in the polymer solution (PL) may be carried out as the isolation of the polyarylene ether sulfone polymer (P) obtained in the product mixture (P_{G}). For example, the isolation may be carried out by precipitation of the polymer solution (PL) in water or mixtures of water with other solvents. The precipitated polyarylene ether sulfone polymer (P) can subsequently be extracted with water and then be dried. In one embodiment of the invention, the precipitate can also be taken up in an acidic medium. Suitable acids are for example organic or inorganic acids for example carboxylic acid such as acetic acid, propionic acid, succinic acid or citric acid and mineral acids such as hydrochloric acid, sulfuric acid or phosphoric acid.

### Component (A1)

The reaction mixture (R_{G}) preferably comprises at least one aromatic dihalogen sulfone as component (A1). The term “at least one aromatic dihalogen sulfone”, in the present case, is understood to mean exactly one aromatic dihalogen sulfone and also mixtures of two or more aromatic dihalogen sulfones. The at least one aromatic dihalogen sulfone (component (A1)) is preferably at least one dihalodiphenyl sulfone.

The present invention therefore also relates to a method in which the reaction mixture (R_{G}) comprises at least one dihalodiphenyl sulfone as component (A1).

The component (A1) is preferably used as a monomer. This means that the reaction mixture (R_{G}) comprises component (A1) as a monomer and not as a prepolymer.

The reaction mixture (R_{G}) comprises preferably at least 50% by weight of a dihalodiphenyl sulfone as component (A1), based on the total weight of component (A1) in the reaction mixture (R_{G}).

Preferred dihalodiphenyl sulfones are the 4,4′-dihalodiphenyl sulfones. Particular preference is given to 4,4′-dichlorodiphenyl sulfone, 4,4′-difluorodiphenyl sulfone and/or 4,4′-dibromodiphenyl sulfone as component (A1). 4,4′-Dichlorodiphenyl sulfone and 4,4′-difluorodiphenyl sulfone are particularly preferred, while 4,4′-dichlorodiphenyl sulfone is most preferred.

In a preferred embodiment component (A1) comprises at least 50% by weight of at least one aromatic dihalogen sulfone selected from the group consisting of 4,4′-dichlorodiphenyl sulfone and 4,4′-difluorodiphenyl sulfone, based on the total weight of component (A1) in the reaction mixture (R_{G}).

In a particularly preferred embodiment, component (A1) comprises at least 80% by weight, preferably at least 90% by weight, more preferably at least 98% by weight, of an aromatic dihalogen sulfone selected from the group consisting of 4,4′-dichlorodiphenyl sulfone and 4,4′-difluorodiphenyl sulfone, based on the total weight of component (A1) in the reaction mixture (R_{G}).

In a further particularly preferred embodiment, component (A1) consists essentially of at least one aromatic dihalogen sulfone selected from the group consisting of 4,4′-dichlorodiphenyl sulfone and 4,4′-difluorodiphenyl sulfone. “Consisting essentially of”, in the present case, is understood to mean that component (A1) comprises more than 99 by weight, preferably more than 99.5% by weight, particularly preferably more than 99.9% by weight, of at least one aromatic dihalogen sulfone compound selected from the group consisting of 4,4′-dichlorodiphenyl sulfone and 4,4′-difluorodiphenyl sulfone, based in each case on the total weight of component (A1) in the reaction mixture (R_{G}). In these embodiments, 4,4′-dichlorodiphenyl sulfone is particularly preferred as component (A1).

In a further particularly preferred embodiment, component (A1) consists of 4,4′-dichlorodiphenyl sulfone.

### Component (B1)

The reaction mixture (R_{G}) preferably comprises at least one dihydroxy component comprising at least 20 mol-% of trimethylhydroquinone, based on the total amount of the at least one dihydroxy component, as component (B1). The term “at least one dihydroxy component”, in the present case, is understood to mean exactly one dihydroxy component and also mixtures of two or more dihydroxy components. Preferably, component (B1) is precisely one dihydroxy component or a mixture of precisely two dihydroxy components. Most preferred component (B1) is precisely one dihydroxy component.

The dihydroxy components used are typically components having two phenolic hydroxyl groups. Since the reaction mixture (R_{G}) comprises at least one carbonate component, the hydroxyl groups of component (B1) in the reaction mixture (R_{G}) may be present partially in deprotonated form.

Component (B1) is preferably used as a monomer. This means that the reaction mixture (R_{G}) comprises component (B1) as monomer and not as prepolymer.

Component (B1) comprises at least 20 mol-% of trimethylhydroquinone based on the total amount of the at least one dihydroxy component. Preferably, component (B1) comprises from 50 to 100 mol-%, more preferably from 80 to 100 mol-% and most preferably from 95 to 100 mol-% of trimethylhydroquinone based on the total amount of the at least one dihydroxy component in the reaction mixture (R_{G}). In a preferred embodiment, component (B1) consists essentially of trimethylhydroquinone.

“Consisting essentially of” in the present case is understood to mean that component (B1) comprises more than 99 mol-%, preferably more than 99.5 mol-%, particular preferably more than 99.9 mol-% of trimethylhydroquinone based in each case on the total amount of component (B1) in the reaction mixture (R_{G}).

In a further preferred embodiment, component (B1) consists of trimethylhydroquinone.

Trimethylhydroquinone is also known as 2,3,5-trimethylhydroquinone. It has the CAS-number 700-13-0. Methods for its preparation are known to the skilled person.

Suitable further dihydroxy components that can be comprised as component (B1) are known to the skilled person and are for example selected from the group consisting of 4,4′-dihydroxybiphenyl and 4,4′-dihydroxydiphenyl sulfone. In principal, other aromatic dihydroxy compounds can also be comprised such as bisphenol A (IUPAC-name: 4,4′-(propane-2,2-diyl)diphenol).

### Component (C)

The reaction mixture (R_{G}) preferably comprises at least one carbonate component as component (C). The term “at least one carbonate component” in the present case, is understood to mean exactly one carbonate component and also mixtures of two or more carbonate components. The at least one carbonate component is preferably at least one metal carbonate. The metal carbonate is preferably anhydrous.

Preference is given to alkali metal carbonates and/or alkaline earth metal carbonates as metal carbonates. At least one metal carbonate selected from the group consisting of sodium carbonate, potassium carbonate and calcium carbonate is particularly preferred as metal carbonate. Potassium carbonate is most preferred.

For example, component (C) comprises at least 50% by weight, more preferred at least 70% by weight and most preferred at least 90% by weight of potassium carbonate based on the total weight of the at least one carbonate component in the reaction mixture (R_{G}).

In a preferred embodiment component (C) consists essentially of potassium carbonate.

“Consisting essentially of” in the present case is understood to mean that component (C) comprises more than 99% by weight, preferably more than 99.5% by weight, particular preferably more than 99.9% by weight of potassium carbonate based in each case on the total weight of component (C) in the reaction mixture (R_{G}).

In a particularly preferred embodiment component (C) consists of potassium carbonate.

Potassium carbonate having a volume weighted average particle size of less than 200 μm is particularly preferred as potassium carbonate. The volume weighted average particle size of the potassium carbonate is determined in a suspension of potassium carbonate in N-methylpyrrolidone using a particle size analyser.

In a preferred embodiment, the reaction mixture (R_{G}) does not comprise any alkali metal hydroxides or alkaline earth metal hydroxides.

### Component (D)

The reaction mixture (R_{G}) preferably comprises at least one aprotic polar solvent as component (D). “At least one aprotic polar solvent”, according to the invention, is understood to mean exactly one aprotic polar solvent and also mixtures of two or more aprotic polar solvents.

Suitable aprotic polar solvents are, for example, selected from the group consisting of anisole, dimethylformamide, dimethylsulfoxide, N-methylpyrrolidone, N-ethylpyrrolidone, diphenylsulfone and N-dimethylacetamide.

Preferably, component (D) is selected from the group consisting of N-methylpyrrolidone, N-dimethylacetamide, dimethylsulfoxide and dimethylformamide. N-methylpyrrolidone is particularly preferred as component (D).

It is preferred that component (D) does not comprise sulfolane. It is furthermore preferred that the reaction mixture (R_{G}) does not comprise sulfolane.

It is preferred that component (D) comprises at least 50% by weight of at least one solvent selected from group consisting of N-methylpyrrolidone, N-dimethylacetamide, dimethylsulfoxide and dimethylformamide based on the total weight of component (D) in the reaction mixture (R_{G}). N-methylpyrrolidone is particularly preferred as component (D).

In a further preferred embodiment, component (D) consists essentially of N-methylpyrrolidone.

“Consist essentially of”, in the present case, is understood to mean that component (D) comprises more than 98% by weight, particularly preferably more than 99% by weight, more preferably more than 99.5% by weight, of at least one aprotic polar solvent selected from the group consisting of N-methylpyrrolidone, N-dimethylacetamide, dimethylsulfoxide and dimethylformamide with preference given to N-methylpyrrolidone.

In a preferred embodiment, component (D) consists of N-methylpyrrolidone. N-methylpyrrolidone is also referred to as NMP or N-methyl-2-pyrrolidone.

### Membrane (M) Used in the Inventive Process for the Separation of Propylene

The membrane (M) used in the inventive process for the separation of propylene is described in more detail hereinafter.

In a preferred embodiment, the membrane (M) comprises a porous support layer, a dense selective layer and a dense coating layer.

In a preferred embodiment the porous support layer forms the retentate side of the membrane (M), the dense coating layer forms the permeate side of the membrane (M) and the selective layer is located between the retentate side and a permeate side of the membrane (M).

The separation of propylene from the gas mixture (GM) is predominantly carried out by the dense selective layer of the membrane (M).

In a particularly preferred embodiment, the dense selective layer of the membrane (M) is formed from the polyarylene ether sulfone polymer (P).

In a particularly preferred embodiment, the porous support layer of the membrane (M) is formed from at least one polymer selected from the groups consisting of polyacrylonitrile, polyimides, polyvinylidenefluoride, wherein the polyarylene ether sulfone polymer (P) is especially preferred.

The dense coating layer of the membrane (M) comprises preferably at least 70% by weight, more preferably at least 90% by weight and most preferably at least 98% by weight of polydimethylsiloxane and/or polydimethylsiloxane copolymers, based on the total weight of dense coating layer of the membrane (M), wherein polydimethylsiloxane is especially preferred .

In a further preferred embodiment, the dense coating layer of the membrane (M) consists essentially of polydimethylsiloxane.

“Consisting essentially of” means that the dense coating layer of the membrane (M) comprises more than 98% by weight, preferably more than 99% by weight and most preferably more than 99.5% by weight of polydimethylsiloxane, based on the total weight of the dense coating layer of the membrane (M).

In a particularly preferred embodiment, the dense coating layer of the membrane (M) is formed from polydimethylsiloxane.

In a particularly preferred embodiment, the porous support layer of the membrane (M) is formed from the polyarylene ether sulfone polymer (P) and the dense coating layer of the membrane (M) is formed from polydimethylsiloxane.

In a preferred embodiment the membrane (M) comprises at least 50% by weight of the polyarylene ether sulfone polymer (P), more preferably at least 70% by weight and most preferably at least 90% by weight of the polyarylene ether sulfone polymer (P) based on the total weight of the membrane (M).

During the preparation of the membrane (M) (as described below) the polyarylene ether sulfone polymer (P) is separated from the at least one solvent. Therefore, the obtained membrane (M) is essentially free from the at least one solvent.

“Essentially free” within the context of the present invention means that the membrane (M) comprises at most 3% by weight, preferably at most 1.5% by weight and particularly preferably at most 0.5% by weight of the at least one solvent based on the total weight of the membrane (M). The preferably membrane (M) comprises at least 0.0001% by weight, more preferably at least 0.001% by weight and particularly preferably at least 0.005% by weight of the at least one solvent based on the total weight of the membrane (M).

In a preferred embodiment of the present invention the membrane (M) is a dense membrane.

If the membrane (M) is a dense membrane then the membrane (M) typically comprises virtually no pores.

A dense membrane is typically obtained by a solution casting process in which a solvent comprised in the casted solution is evaporated. Usually the dense separation layer (the solution which after the evaporation of the solvent gives the dense separation layer) is casted on the porous support layer, which might be another polymer like polysulfone, preferably the polyarylene ether sulfone polymer (P), polyacrylonitrile and/or celluloseacetate. On top of the dense separation layer preferably a dense coating layer, preferably of polydimethylsiloxane is applied.

The membrane (M) can have any thickness. For example, the thickness of the membrane (M) is in the range from 1 to 300 μm, preferably in the range from 3 to 200 μm and most preferably in the range from 5 to 100 μm.

### Membrane Preparation

Processes for the preparation of the membrane (M) used in the inventive process for the separation of propylene are known to the person skilled in the art.

Preferably, a membrane (M) is used obtained by a process comprising the steps

i) providing a solution (S) which comprises the polyarylene ether sulfone polymer (P) and at least one solvent,

ii) separating the at least one solvent from the solution (S) to obtain the membrane (M).

### Step i)

In step i) a solution (S) is provided which comprises the polyarylene ether sulfone polymer (P) and at least one solvent.

“At least one solvent” within the context of the present invention means precisely one solvent also a mixture of two or more solvents.

The solution (S) can be provided in step i) by any method known to the skilled person. For example, the solution (S) can be provided in step i) in customary vessels which may comprise a stirring device and preferably a temperature control device. Preferably, the solution (S) is provided by dissolving the polyarylene ether sulfone polymer (P) in the at least one solvent.

The dissolution of the polyarylene ether sulfone polymer (P) in the at least one solvent to provide the solution (S) is preferably achieved under agitation.

Step i) is preferably carried out at elevated temperatures, especially in the range from 20 to 120° C., more preferably in the range from 40 to 100° C. A person skilled in the art will choose the temperature in accordance with the at least one solvent.

The solution (S) preferably comprises the polyarylene ether sulfone polymer (P) completely dissolved in the at least one solvent. This means that the solution (S) preferably comprises no solid particles of the polyarylene ether sulfone polymer (P).

Therefore, the polyarylene ether sulfone polymer (P) preferably cannot be separated from the at least one solvent by filtration.

The solution (S) preferably comprises from 0.001 to 50% by weight of the polyarylene ether sulfone polymer (P) based on the total weight of the solution (S). More preferably, the solution (S) in step i) comprises from 0.1 to 35% by weight of the polyarylene ether sulfone polymer (P) and most preferably the solution (S) comprises from 0.5 to 25% by weight of the polyarylene ether sulfone polymer (P) based on the total weight of the solution (S).

As the at least one solvent, any solvent known to the skilled person for the polyarylene ether sulfone polymer (P) is suitable. Preferably, the at least one solvent is soluble in water. Therefore, the at least one solvent is preferably selected from the group consisting of N-methylpyrrolidone, dimethylacetamide, dimethylsulfoxide, dimethyllactamide, dimethylformamide and sulfolane. N-methylpyrrolidone and dimethyllactamide are particularly preferred. Dimethyllacetamide and N-methylpyrrolidone are most preferred as the at least one solvent.

The solution (S) preferably comprises in the range from 50 to 99.999% by weight of the at least one solvent, more preferably in the range from 70 to 99.9% by weight and most preferably in the range from 75 to 99.5% by weight of the at least one solvent based on the total weight of the solution (S).

The solution (S) provided in step i) can furthermore comprise additives for the membrane preparation.

Suitable additives for the membrane preparation are known to the skilled person and are, for example, polyvinylpyrrolidone (PVP), polyethylene oxide (PEO), polyethylene oxide-polypropylene oxide copolymer (PEO-PPO) and poly(tetrahydrofurane) (poly-THF). Polyvinylpyrrolidone (PVP) and polyethylene oxide (PEO) are particularly preferred as additives for the membrane preparation.

The additives for membrane preparation can, for example, be comprised in the solution (S) in an amount of from 0.00 to 20% by weight, preferably in the range from 0.01 to 15% by weight and more preferably in the range from 0.1 to 10% by weight based on the total weight of the solution (S).

To the person skilled in the art it is clear that the percentages by weight of the polyarylene ether sulfone polymer (P) the at least one solvent and the optionally comprised additive for membrane preparation comprised in the solution (S) typically add up to 100% by weight.

The duration of step i) may vary between wide limits. The duration of step i) is preferably in the range from 10 min to 96 h (hours), especially in the range from 10 min to 48 h and more preferably in the range from 15 min to 12 h. A person skilled in the art will choose the duration of step i) so as to obtain a homogeneous solution of the polyarylene ether sulfone polymer (P) in the at least one solvent.

Furthermore, degassing and filtration steps can be applied to improve the homogeneity of the solution (S).

For the polyarylene ether sulfone polymer (P) comprised in the solution (S) the embodiments and preferences given for the polyarylene ether sulfone polymer (P) obtained in the inventive process hold true.

### Step ii)

In step ii) the at least one solvent is separated from the solution (S) to obtain the dense separation layer of the membrane (M). It is possible to filter the solution (S) provided in step i) before the at least one solvent is separated from the solution (S) in step ii) to obtain a filtered solution (fS). The following embodiments and preferences for separating the at least one solvent from the solution (S) applies equally for separating the at least one solvent from the filtered solution (fS) which is used in this embodiment of the invention.

The separation of the at least one solvent from the solution (S) can be performed by any method known to the skilled person which is suitable to separate solvents from polymers.

Preferably, the separation of the at least one solvent from the solution (S) is carried out via a phase inversion process.

A phase inversion process within the context of the present invention means a process wherein the dissolved polyarylene ether sulfone polymer (P) is transformed into a solid phase. Therefore, a phase inversion process can also be denoted as precipitation process. According to step ii) the transformation is performed by separation of the at least one solvent from the polyarylene ether sulfone polymer (P). The person skilled in the art knows suitable phase inversion processes.

The phase inversion process can, for example, be performed by cooling down the solution (S). During this cooling down, the polyarylene ether sulfone polymer (P) comprised in this solution (S) precipitates. Another possibility to perform the phase inversion process is to bring the solution (S) in contact with a aqueous liquid that is a non-solvent for the polyarylene ether sulfone polymer (P). The polyarylene ether sulfone polymer (P) will then as well precipitate. Suitable aqueous liquids that are non-solvents for the polyarylene ether sulfone polymer (P) are for example protic polar solvents described hereinafter in their liquid state. Another phase inversion process which is preferred within the context of the present invention is the phase inversion by immersing the solution (S) into at least one protic polar solvent.

Therefore, in one embodiment, in step ii) the at least one solvent comprised in the solution (S) is separated from the polyarylene ether sulfone polymer (P) comprised in the solution (S) by immersing the solution (S) into at least one protic polar solvent.

This means that the dense separation layer of the membrane (M) is formed by immersing the solution (S) into at least one protic polar solvent.

Suitable at least one protic polar solvents are known to the skilled person. The at least one protic polar solvent is preferably a non-solvent for the polyarylene ether sulfone polymer (P).

Preferred at least one of protic polar solvents are water, methanol, ethanol, n-propanol, iso-propanol, glycerol, ethyleneglycol and mixtures thereof.

Step ii) usually comprises a provision of the solution (S) in a form that corresponds to the form of the dense separation layer of the membrane (M) which is obtained in step ii).

Therefore, in one embodiment of the present invention step ii) comprises a casting of the solution (S) to obtain a film of the solution (S) or a passing of the solution (S) through at least one spinneret to obtain at least one hollow fiber of the solution (S).

Therefore, in one preferred embodiment, step ii) comprise the following steps:

ii-1) casting the solution (S) provided in step i) to obtain a film of the solution (S),

ii-2) evaporating the at least one solvent from the film of the solution (S) obtained in step ii-1) to obtain the dense separation layer of the membrane (M) which is in the form of a film.

This means that the dense separation layer of the membrane (M) is formed by evaporating the at least one solvent from a film of the solution (S).

In step ii-1) the solution (S) can be cast by any method known to the skilled person. Usually, the solution (S) is cast with a casting knife that is heated to a temperature in the range from 20 to 150° C., preferably in the range from 40 to 100° C.

The solution (S) is usually cast on a substrate that does not react with the polyarylene ether sulfone polymer (P) or the at least one solvent comprised in the solution (S).

Preferably the solution (S) is casted on the porous support layer. The solution can as well be casted on an inert substrate by spin-coating.

To obtain the dense separation layer of the membrane (M), the separation in step ii) is typically carried out by evaporation of the at least one solvent comprised in the solution (S).

To obtain a hollow fiber membrane, a dry-wet spinning process can be employed. The solution (S) can have different polymer concentration to vary the surface porosities and the pore size of the porous inner layer. To minimize the transport resistance, highly porous support layers are preferred. Hence bore fluids with high solvent content are preferred. The solvent content in the bore fluid is preferably more than 50 wt. %. For the formation of a highly defect free selective layer precipitation in a polar precipitation bath is preferred. Precipitation in water comprising less than 50 wt.% of further water miscible solvents like ethanol, propanol or 1,3-propanediol is preferred. Further details regarding the preparation of hollow fibers from the solutions (S) are given in T.-S. Chung et. al., Journal of Membrane Science 541 (2017) 367. Furthermore, to prepare a highly defect free selective layer, spinning at high shear rates is essential. To obtain high selectivity for the C₃H₆/C₃H₈-separation, spinning at shear rates of higher than 5000 s⁻¹ is preferred.

The hollow fibers are then coated on the outside by a dip-coating process with a layer of Polydimethylsiloxane, in order to establish the dense coating layer. Details about this process can also be found in T.-S. Chung et. al., Journal of Membrane Science 541 (2017) 367.

### Process for the Separation of Propylene From the Gas Mixture (GM)

In a preferred embodiment of the inventive process for the separation of propylene from a gas mixture (GM), comprising propylene and propane by means of a membrane (M), the membrane (M) comprises a retentate side and a permeate side, and the gas mixture (GM) is contacted with the retentate side of the membrane (M).

The propylene comprised in the gas mixture (GM) permeates to the permeate side of the membrane (M) to obtain a propylene enriched permeate on the permeate side of the membrane (M) and a propylene depleted retentate is obtained on the retentate side of the membrane (M).

Another object of the present invention is therefore a process, wherein the membrane (M) comprises a retentate side and a permeate side and wherein the gas mixture (GM) is contacted with the retentate side of the membrane (M) and the propylene permeates to the permeate side of the membrane (M) to obtain a propylene enriched permeate and a propylene depleted retentate.

The gas mixture (GM) typically comprises 10 to 90% of a propylene, 10 to 90% of propane and 0 to 80% of other gases, in each case based on the total weight of the gas mixture (GM).

Other gases comprised in the gas mixture are preferably one or more selected from the group consisting of Hydrogen or other hydrocarbon compounds.

The pressure of the retentate side of the membrane (M) can be higher, lower or equal to the pressure of the permeate side of the membrane (M). In a preferred embodiment, the pressure on the retentate side of the membrane (M) is higher than the pressure of the permeate side of the membrane (M). The pressure difference is typically in the range of 2 to 15 bar.

The present invention is further elucidated by the following working examples without limiting it thereto.

### EXAMPLES

### Components Used

DCDPS: 4,4′-dichlorodiphenyl sulfone,

TMH: trimethylhydroquinone,

DHDPS: 4,4′-dihydroxydiphenyl sulfone,

Bisphenol A: 4,4′-(propane-2,2-diyl)diphenol,

Potassium carbonate: K₂CO₃; anhydrous; volume-average particle size of 32.4 μm,

NMP: N-methylpyrrolidone,

PESU: polyethersulfone (ULTRASON® E 3010)

PPSU: polyphenylensulfone (ULTRASON® P 3010)

DMAc: dimethylacetamide

### General Procedures

The viscosity number of the polymers is determined in a 1% solution in NMP at 25° C.

The isolation of the polymers is carried out by dripping an NMP solution of the polymers in demineralized water at room temperature (25° C.). The drop height is 0.5 m, the throughput is about 2.5 l/h. The beads obtained are then extracted with water (water throughput 160 l/h) at 85° C. for 20 h. The beads are dried at 150° C. for 24 h (hours) at reduced pressure (<100 mbar).

The glass transition temperature of the obtained products is determined via differential scanning calorimetry at a heating ramp of 10 K/min in the second heating cycle.

The number average molecular weights (Mₙ) and the weight average molecular weights (M_{w}) are determined via GPC in DMAc/LiBr with PMMA (poly(methylmethacrylate)) standards.

The content of methyl-endgroups is measured by ¹H-NMR, integrating the signals between 3.8 and 4 ppm (CDCl₃/TMS). The content of Cl-endgroups is measured by the Cl-content of the samples and is determined by tube incineration.

The content of OH-endgroups is determined by potentiometric titration.

The thermal stability of the obtained polymers is measured by thermogravimetric analysis. For the measurement a Netsch STA 449F3-instrument was used. The measurement was carried out by the following method: The sample was dried for 24 h in vacuum (pressure <1 mbar) at 150° C. Under air the sample is then heated to 380° C. with a heating rate of 20 K/min and held at this temperature for 30 min. “loss heating” gives the loss of mass during the heating; “loss annealing” gives the loss of mass during the 30 min holding.

### Example 1: Polyarylene Ether Sulfone Polymer (P)

In a 4 liter glass reactor equipped with a thermometer, a gas inlet tub and a Dean-Stark-trap, 574.34 g (2.00 mol) of DCDPS, 304.38 g (2.00 mol) of TMH and 290.24 g (2.10 mol) of potassium carbonate are suspended in 950 ml NMP in a nitrogen atmosphere. The mixture is heated to 190° C. within one hour. The water of reaction is continuously distilled off. After a reaction period of 8 h (hours), the reaction is stopped by dilution of NMP (2050 ml). The reaction period is considered to be the residence time at 190° C. The mixture is cooled down to room temperature within one hour and the potassium chloride produced is filtered off.

Example 2: Polyarylene Ether Sulfone Polymer (P) PTPESU 1

In a 4 liter glass reactor equipped with a thermometer, a gas inlet tube and a Dean-Stark-trap, 574.34 g (2.00 mol) of DCDPS, 304.38 g (2.00 mol) of TMH and 290.24 g (2.10 mol) of potassium carbonate are suspended in 950 ml NMP in a nitrogen atmosphere. The mixture is heated to 190° C. within one hour. The water of reaction is continuously distilled off. After a reaction period of 8 h (hours), the product mixture is cooled to 130° C. by addition of NMP (1000 ml). The reaction period is considered to be the residence time at 190° C. Then 50 g methylchloride are added to the reactor over a period of 60 min, then the mixture is purged with nitrogen for 30 min and finally, after the addition of NMP (1050 ml) cooled down to room temperature. The potassium chloride produced is filtered off.

### Example 3: Polyarylene Ether Sulfone Polymer (P), PTPESU 2

In a 4 liter glass reactor equipped with a thermometer, a gas inlet tube and a Dean-Stark-trap, 574.34 g (2.00 mol) of DCDPS, 153.66 g (1.01 mol) of TMH, 250.28 g (1.00 mol) DHDPS and 290.24 g (2.10 mol) of potassium carbonate are suspended in 950 ml NMP in a nitrogen atmosphere. The mixture is heated to 190° C. within one hour. The water of reaction is continuously distilled off. After a reaction period of 8 h (hours), the product mixture is cooled to 130° C. by addition of NMP (1000 ml). The reaction period is considered to be the residence time at 190° C. Then 50 g methylchloride are added to the reactor over a period of 60 min, then the mixture is purged with nitrogen for 30 min and finally, after the addition of NMP (1050 ml) cooled down to room temperature. The potassium chloride produced is filtered off.

### Example 4: Polyarylene Ether Sulfone Polymer (P)

In a 4 liter glass reactor equipped with a thermometer, a gas inlet tube and a Dean-Stark-trap, 574.34 g (2.00 mol) of DCDPS, 307.36 g (2.02 mol) of TMH and 290.24 g (2.10 mol) of potassium carbonate are suspended in 950 ml NMP in a nitrogen atmosphere. The mixture is heated to 190° C. within one hour. The water of reaction is continuously distilled off. After a reaction period of 8 h (hours), the product mixture is cooled to 130° C. by addition of NMP (1000 ml). The reaction period is considered to be the residence time at 190° C. Then 50 g methylchloride are added to the reactor over a period of 60 min, then the mixture is purged with nitrogen for 30 min and finally, after the addition of NMP (1050 ml) cooled down to room temperature. The potassium chloride produced is filtered off.

### Comparative Example 5

A polyarylene ether sulfone polymer was prepared according to the procedure given in literature (Rose et al., Polymer 1996, 37, 1735). DCDPS, TMH and potassium carbonate were used in sulfolane as solvent and toluene as aceotropic agent. In comparative example 4, the reaction period was 8 h at 250° C. and in comparative example 5, the reaction period was 10 h at 250° C.

### Comparative Example 6

In a 4 liter glass reactor equipped with a thermometer, a gas inlet tube and a Dean-Stark-trap, 574.34 g (2.00 mol) of DCDPS, 250.28 g (1.00 mol) of DHDPS, 171.21 g (0.75 mol) of Bisphenol A, 38.04 g (0.25 mol) of TMH and 304.06 g (2.20 mol) of potassium carbonate are suspended in 950 ml NMP in a nitrogen atmosphere. The mixture is heated to 190° C. within one hour. The water of reaction is continuously distilled off. After a reaction period of 8 h (hours), the product mixture is cooled to 130° C. by addition of NMP (1000 ml). The reaction period is considered to be the residence time at 190° C.

Then 50 g methylchloride are added to the reactor over a period of 60 min, then the mixture is purged with nitrogen for 30 min and finally, after the addition of NMP (1050 ml) cooled down to room temperature. The potassium chloride produced is filtered off.

The obtained properties of the prepared polymers and of neat PESU as comparative example 7 are shown in table 1.

TABLE 1

| | | Ex. 2 | Ex. 3 | | Comp. | Comp. | Comp. |
|---|---|---|---|---|---|---|---|
| | Ex. 1 | PTPESU1 | PTPESU2 | Ex. 4 | Ex. 5 | Ex. 6 | Ex. 7 |
| polymer | PESU- | PESU- | PESU- | PESU- | PESU- | Copoly- | PESU |
| | TMH | TMH | TMH | TMH | TMH | mer | |
| V.N. | 65.8 | 66.7 | 66.1 | 62.5 | 53.1 | 49.7 | 84.5 |
| [ml/g] | | | | | | | |
| M_{w} | 87.4 | 88.4 | 86.2 | 72.3 | 62.9 | 55.2 | 77.5 |
| [kg/mol] | | | | | | | |
| Mₙ | 19.6 | 19.9 | 21.0 | 18.4 | 12.9 | 11.7 | 20.0 |
| [kg/mol] | | | | | | | |
| M_{w}/Mₙ | 4.46 | 4.44 | 4.10 | 3.93 | 4.88 | 4.72 | 3.88 |
| Tg [° C.] | 248 | 249 | 236 | 248 | 248 | 215 | 226 |
| End- | | | | | | | |
| groups | | | | | | | |
| Cl [%] | 46 | 43 | 16 | 14 | 48 | 48 | 45 |
| OMe [%] | — | 57 | 79 | 77 | — | 52 | 55 |
| OH [%] | 54 | — | 5 | 9 | 52 | — | — |
| Loss | 0.34 | 0.35 | 0.26 | 0.22 | 0.45 | 0.47 | 0.19 |
| heating | | | | | | | |
| [wt .-%] | | | | | | | |
| Loss | 2.8 | 2.9 | 1.6 | 1.6 | 3.9 | 4.5 | 1.5 |
| annealing | | | | | | | |
| [wt .-%] | | | | | | | |

It can clearly be seen that by the inventive process higher molecular weights and a narrower molecular weight distribution for the polymers can be obtained. Moreover, the thermal stability of the polymers obtainable by the inventive process is significantly higher.

### Gas Separation Membranes

The hollow fiber membranes were fabricated by adopting the dry-wet spinning process that can be found elsewhere (T.-S. Chung, J. Membr. Sci. 541 (2017) 367). The outer diameter (OD) and inner diameter (ID) of the spinneret's channels were 1.2 and 0.8 mm, respectively. The detailed hollow fiber spinning conditions and parameters were tabulated in Table 2. Briefly, to produce the hollow fibers, the following procedures were applied. (1) Dope preparation: the polymer/NMP mixture was stirred continuously in a 2-neck round-bottom glass flask with a mechanical stirrer (IKA®, EUROSTAR, EURO-ST D) at 60° C. overnight. (2) Spinning: the dope and bore fluid were transferred to ISCO syringe pumps and degassed overnight; the hollow fibers were spun according to the specific conditions (see in Table 2). (3) Post treatment: the as-spun hollow fibers were cut and soaked in a water bath for 3 days with daily water change to remove the residual solvent. (4) Drying: the hollow fibers were dried by using a solvent exchange method, where the fibers were immersed into a circulating fresh methanol bath for 30 min for three times, and then repeated the same procedures using n-hexane. The solvent exchanged fibers were dried in air at room temperature (e.g. ˜25° C.) for at least 24 h. Then the as-dried fibers were used for tests and other characterizations.

The fibers were then assembled to modules. The hollow fiber membrane module containing 10-20 pieces of hollow fibers was fabricated according to the protocol as described previously (T.-S. Chung, J. Membr. Sci. 541 (2017) 367). Briefly, one end of the hollow fibers was sealed with a fast-setting epoxy resin (Araldite®, Switzerland), while the other end was embedded in an aluminum holder by applying a regular epoxy resin. The effective length of hollow fibers was about 15 cm.

The pristine hollow fiber membrane modules were undergone gas permeation tests prior to the PDMS coating. To recover the selectivity of hollow fibers, the hollow fiber membranes were coated by silicon rubber or PDMS (Sylgard®184) using a 3.0 wt % PDMS solution in hexane after module fabrication. The membranes were dipped into the PDMS solution for about 5 min. Subsequently, the membranes were dried and cured in air at room temperature for at least 48 h.

Pure gas permeation tests of hollow fiber membranes were carried out at ambient temperature (˜25° C.) using a permeation cell system as described elsewhere (T.-S. Chung, J. Membr. Sci. 541 (2017) 367). The gas permeate flow rate was determined using a universal gas flowmeter (Agilent, ADM1000, 0.5-1000 ml/min), and a manual soap bubble flow meter (effective measuring volume=0.50 ml, marking height=10 cm). The manual soap bubble flow meter was used because it was able to determine an extremely low gas flow rate with high accuracy (e.g. <0.01 ml/min). For the condensable gases (e.g. ethane, ethylene, propane and propylene), the hollow fibers were conditioned at each testing pressure for at least 30 min in order to allow the development of plasticization and achieve a steady permeate flux. At least three membrane modules were produced for each spinning condition for gas permeation tests. Unless stated otherwise, the average results were reported in this work.

The pure gas permeance (J) can be calculated according to the following equation:

$$J = \frac{P}{L} = \frac{Q}{A Δ P} = \frac{Q}{n π {DL}_{m} Δ P} \qquad ( 3 )$$

where Q is the gas permeate flow rate (cm³/min), n is the number of fibers in each module, D is the outer diameter of hollow fibers (cm), Lₘ is the effective length of hollow fibers (cm), and ΔP is the transmembrane pressure difference (cmHg). The unit of permeance is GPU (1 GPU=1−10⁻⁶ cm³ (STP)/(cm² s cmHg)). The pure gas permeance selectivity (α_{i/j}) is defined as:

$${α}_{i / j} = \frac{{J}_{i}}{{J}_{j}} \qquad ( 4 )$$

where, Jᵢ and Jⱼ are the permeances of gases i and j, respectively.

The mixed gas tests were conducted for the defect-free hollow fiber membrane at room temperature (25±2° C.). An equal-molar mixed gas (propane/propene=50/50 mol%) was used as the feed. A transmembrane pressure of 5 bar (5 bar was the maximum stable pressure of the mixed gas at the ambient conditions in our laboratory) was applied for the mixed gas permeation tests. The compositions of the permeate were analyzed using a gas chromatography (GC; Agilent, 7890A).

TABLE 2

| Sample | PTPESU1 | PTPESU2 | PESU |
|---|---|---|---|
| Bore Fluid Comp. | NMP/water = 95/5 | | |
| [wt. %] | | | |
| Air gap [cm] | 5.0 | | |
| Temperature [° C.] | Room temp. (appr. 25) | | |
| External Coag. | Tap water | | |
| Dope composition | PTPESU1/ | PTPESU2/ | PESU/NMP/ |
| [wt. %] | NMP | NMP | Ethanol |
| | 33/67 | 33/67 | 34/56/10 |
| Dope flow rate | 10 | 10 | 10 |
| [ml/min] | | | |
| Bore fluid flow rate | 6 | 6 | 6 |
| [ml/min] | | | |
| Take-up speed | 60 | 60 | 60 |
| [m/min] | | | |
| Shear rate | 7539 | 7450 | 7360 |
| [s⁻¹] | | | |
| Permeance C₃H₆ | 181.5 | 123.3 | 13.2 |
| [GPU] | | | |
| Selectivity | 184 | 125.1 | 2.1 |
| C₃H₆/C₃H₈ | | | |

To check the durability of the new membranes, pure gas filtration tests with C₃H₆ and C₃H₈ were run for 90 days. The selectivity of C₃H₆/C₃H₈ for the fiber based on PTPESU1 only dropped from about 184 to 150 during this time.

It can clearly be seen from Table 2 that the inventive membranes show an exceptionally higher selectivity compared to the reference membranes based on PESU for the mixture C₃H₆/C₃H₈.

1-15. (canceled)

16. A process for the separation of propylene from a gas mixture (GM) comprising propylene and propane by means of a membrane (M) comprising a polyarylene ether sulfone polymer (P) prepared by converting a reaction mixture (R_{G}) comprising at least one aromatic dihalogen sulfone and at least one dihydroxy component comprising trimethylhydroquinone.

17. The process according to claim 16, wherein the membrane (M) comprises a retentate side and a permeate side and wherein the gas mixture (GM) is contacted with the retentate side of the membrane (M) and the propylene permeates to the permeate side of the membrane (M) to obtain a propylene enriched permeate and a propylene depleted retentate.

18. The process according to claim 16, wherein the preparation of the polyarylene ether sulfone polymer (P) comprises the step
I) converting a reaction mixture (R_{G}) comprising as components
(A1) at least one aromatic dihalogen sulfone,
(B1) at least one dihydroxy component comprising at least 20 mol-% of trimethylhydroquinone based on the total amount of the at least one dihydroxy component,
(C) at least one carbonate component,
(D) at least one aprotic polar solvent.

19. The process according to claim 18, wherein in step I) a first polymer (P1) is obtained and wherein the preparation additionally comprises step
II) reacting the first polymer (P1) obtained in step I) with an alkyl halide.

20. The process according to claim 18, wherein component (B1) comprises from 40 to 100 mol-% of trimethylhydroquinone based on the total amount of the at least one dihydroxy component.

21. The process according to claim 18, wherein component (D) is selected from the group consisting of N-methylpyrrolidone, N-dimethylacetamide, dimethylsulfoxide, and dimethylformamide.

22. The process according to claim 18, wherein the molar ratio of component (B1) to component (A1) in the reaction mixture (R_{G}) is in the range from 0.97 to 1.08.

23. The process according to claim 16, wherein the membrane (M) comprises a porous support layer, a dense selective layer and a dense coating layer.

24. The process according to claim 23, wherein the porous support layer forms the retentate side of the membrane (M), the dense support layer forms the permeate side of the membrane (M) and the selective layer is located between the retentate side and a permeate side of the membrane (M).

25. The process according to claim 23, wherein the dense selective layer of the membrane (M) is formed from the polyarylene ether sulfone polymer (P).

26. The process according to claim 23, wherein the porous support layer of the membrane (M) is formed from a polymer selected from the group consisting of the polyarylene ether sulfone polymer (P), polyacrylonitrile, polyimides, polyvinylidenefluoride and the dense coating layer of the membrane (M) is formed from a polymer selected from the group consisting of polydimethylsiloxane and polydimethylsiloxane-copolymers.

27. The process according to claim 16, wherein the membrane (M) is a hollow fiber membrane spun at a shear rate of at least 5000 s⁻¹.

28. The process according to claim 16, wherein the preparation of the membrane (M) comprises the steps
i) providing a solution (S) which comprises the polyarylene ether sulfone polymer (P) and at least one solvent,
ii) separating the at least one solvent from the solution (S) to obtain the membrane (M).

29. The process according to claim 28, wherein for the preparation of the membrane (M) at least one solvent is selected from the group consisting of N-methylpyrrolidone, dimethylacetamide, dimethyl sulfoxide, dimethylformamide and sulfolane is used.

30. A method comprising utilizing a polyarylene ether sulfone polymer (P) prepared by converting a reaction mixture (R_{G}) comprising at least one aromatic dihalogen sulfone and at least one dihydroxy component comprising trimethylhydroquinone in a process for the separation of propylene from a gas mixture (GM) comprising propylene and propane.
